(19) United States
(12) Patent Application Publication
(10) Pub. No.: US 2005/0166732 A1
(43) Pub. Date: Aug. 4, 2005

(54) Insulation cutting apparatus

(76) Inventor: John A. Valsoaney, Sussex, NJ (US)

Correspondence Address: FRISHAUF, HOLTZ, GOODMAN & CHICK, PC, 220 5TH AVE FL 16, NEW YORK, NY, 10001-7708, US

(21) Appl. No.: 10/770,743

(22) Filed: Feb. 2, 2004

(51) Int. Cl. B26D 7/14

(52) U.S. Cl. 83/19; 83/513

(57) ABSTRACT

Cutting apparatus for cutting insulation including a rigid base defining an elongate slot extending from an upper surface thereof to a lower surface thereof and a handle arranged in connection with the base to enable the base to be manually placed over the insulation material. A cutting implement can be passed through the slot when the base overlies the insulation material to thereby cut the insulation material. A safe and effective way to cut insulation in a single cutting stroke and in an almost guaranteed straight line is therefore provided.

### FIELD OF THE INVENTION

The present invention relates generally to an apparatus for cutting material having a significant width, and more particularly to an apparatus for cutting insulation material for use in insulating buildings.

### BACKGROUND OF THE INVENTION

Insulation material for buildings typically is sold in the form of a compacted roll in various lengths, widths and thicknesses. During installation, the roll is cut into pieces having the desired length to fit, for example, in channels defined between support beams of a ceiling, floor or wall.

Cutting the roll of insulation material into pieces having desired lengths is usually done using a hand-held knife, razor blade, scissors or the like. This however often does not provide an even cut since the insulation material is difficult to securely restrain in view of its thickness when in an unrolled form and the absence of any guide structure to guide the manual cutting stroke in a straight line. Moreover, in view of the relatively significant thickness of the insulation material, it is nearly impossible to cut entirely through the insulation material in a single cut and thus multiple cuts must usually be made. Also, when cutting insulation in its unrolled form, the expanded nature of the insulation causes particles of the insulation to separate from the body of the insulation material. On the other hand, if the insulation is cut while still in the roll form, the cutting may extend through more than one convolution of material and inadvertently cut through an underlying convolution.

Therefore, it would be advantageous to provide an apparatus to cut insulation in its unrolled form which provides a restraint for the insulation to facilitate cutting thereof.

### OBJECTS AND SUMMARY OF THE INVENTION

It is an object of the present invention to provide a new and improved apparatus for cutting material having a significant width and in particular for cutting rolls of insulation material when in an unrolled form.

Another object of the present invention is to provide an easy-to-use, inexpensive and effective product to help cut insulation.

It is still another object of the present invention to provide an apparatus which enables insulation to be cut in a safe manner.

Still another object of the present invention is to provide an apparatus which enables insulation material to be cut entirely through its width in a single cutting stroke.

In order to achieve these objects and others, a cutting apparatus for cutting insulation in accordance with the invention comprises a rigid base defining an elongate slot extending from an upper surface thereof to a lower surface thereof and a handle arranged in connection with the base to enable the base to be manually placed over the insulation material. A cutting implement can be passed through the slot when the base overlies the insulation material to thereby cut the insulation material. A safe and effective way to cut insulation in an almost guaranteed straight line is therefore provided.

The slot may be positioned on the base relative to left and right edges thereof to provide an overhang on either side of the slot. When used to cut insulation material, this overhang, which may be about 6 inches or more, prevents insulation material from interfering with the cutting stroke.

The cutting implement may be formed in connection with the base or separate therefrom, e.g., a razor blade or knife. In one construction in which the cutting implement is formed in connection with the base, two tracks are arranged in connection with the base parallel to and along a respective side of the slot and a cutting tool slides along the tracks and includes a blade arranged to pass through the slot. The cutting tool includes a handle attached to the blade to facilitate movement of the blade through the slot. A cross-piece of the cutting tools is connected to the handle and slides along the tracks.

### BRIEF DESCRIPTION OF THE DRAWINGS

The invention, together with further objects and advantages thereof, may best be understood by reference to the following description taken in conjunction with the accompanying drawings, wherein like reference numerals identify like elements.

FIG. 1 is a perspective view of a first embodiment of an apparatus in accordance with the invention.

FIG. 2 is a top plan view of the first embodiment of the apparatus in accordance with the invention shown in FIG. 1.

FIG. 3 is a top plan view of a second embodiment of the apparatus in accordance with the invention.

FIG. 4 is a top plan view of the apparatus in accordance with the invention during use.

FIG. 5 is a cross-sectional view taken along the line 5-5 in FIG. 4 with the addition of a cutting implement in the slot of the apparatus.

FIG. 6 is a top plan view of a third embodiment of the apparatus in accordance with the invention.

FIG. 7 is a cross-sectional view taken along the line 7-7 of FIG. 6.

### DETAILED DESCRIPTION OF THE INVENTION

Referring to the accompanying drawings wherein like reference numerals refer to the same or similar elements, an apparatus for cutting insulation material in accordance with the invention is designated generally as 10 and comprises a base 12 having an elongate slot 14, and a handle 16 arranged in connection with the base 12. Base 12 may be made of a rigid material such as durable plastic or metal and has a generally planar form. Slot 14 extends entirely through the thickness of the base 12 from a lower surface of the base to an upper surface of the base 12.

The slot 14 is straight and parallel to the right and left edges of the base 12 and wide enough to allow a cutting implement, such as a razor blade or razor knife, to pass therethrough. Thus, the slot 14 will typically be about 0.25 inches wide. The length of the slot 14 may vary in view of variations in the width of different types of insulation or other materials to be cut using the apparatus 10. For insulation, the slot 14 may have a length of 16 inches (the embodiment shown in FIG. 2), for use primary in cutting insulation having a width of about 15 inches, and a length of about 25 inches (the embodiment shown in FIG. 3), for use primarily in cutting insulation having a width of about 24 inches.

The slot 14 preferably has a larger length than the width of the insulation material in order to ensure that the upper and lower edges of the insulation material can be seen through the slot 14. That is, when cutting 15 inch wide insulation, since the slot 14 has a length of about 16 inches, there is a 1 inch excess space in the slot 14. The insulation material can thus be placed so that the underlying surface against which the insulation material is placed, is viewed through the slot 14 both at the upper end and at the lower end of the slot 14. Proper positioning of the insulation material relative to the slot 14 will therefore ensure that a cut through the slot 14 cuts across the entire width of the insulation material.

The slot 14 is arranged on one side of the base 12 and may be centered vertically so that there is approximately the same distance between the upper end of the slot 14 and the upper edge of the base 12 as between the lower end of the slot 14 and the lower edge of the base 12. This distance is about 2.5 inches so that for an apparatus with a slot 14 having a length L1 of 16 inches, the height of the base 12 is about 21 inches (designated H1 in FIG. 2) and for an apparatus with a slot 14 having a length L2 of 25 inches, the height of the base 12 is about 30 inches (designated H2 in FIG. 3). It is foreseen that the distance between one end of the slot 14 and an edge of the base 12 is sufficient such that the apparatus will not fracture or crack at this point when pressure is applied during use, or when the apparatus is inadvertently dropped. This distance will vary depending upon the type and thickness of the material from which the base is fabricated.

Also, the slot 14 is positioned on the base 12 relative to the left and right edges thereof to provide an overhang on either side so that the insulation being cut does not interfere with the cutting movement. The overhang is preferably at least about 6 inches. That is, when the insulation is not compressed below the base 12, it will expand to its uncompressed thickness and potentially interfere with the cutting movement. Accordingly, in one embodiment, the slot 14 is distanced about 6 inches from the right edge of the base 12 and the total width of the base is about 18 inches with the handle being situated about 6 inches from the slot 14 and thus about 6 inches from the left edge of the base 12. The slot 14 is thus distanced about 6 inches from the handle 16.

Handle 16 may be formed separate from the base 12 and attached thereto, for example, by screws and the like, or may be formed integral with the base 12, i.e., from the same plastic material as the base 12 and/or in the same plastic mold as the base 12. Handle 16 can also be formed from foam for comfort considerations. The handle 16 has a gripping section 18 elevated apart from the base 12 and two legs 20 extending between the gripping section 18 and the base 12. The bottom region of each leg 20 is connected to the base 12. The size of the gripping section 18 of the handle 16 may be about 6 inches long and about 1 inch wide.

In the illustrated embodiment, the handle 16 is vertically oriented and parallel to the right and left edges of the base 12, and thus oriented in the same direction as the slot 14. However, the handle 16 can be oriented in a different direction relative to the left and right edges of the base 12 as well as in a different direction relative to the slot 14.

The handle 16 is arranged on an opposite side of the base 12 from the slot 14 and may be centered vertically so that there is approximately the same distance between the upper end of the handle 16 and the upper edge of the base 12 as between the lower end of the handle 16 and the lower edge of the base 12. This distance may be about 12 inches. In the alternative, the handle 16 can be off-centered vertically, i.e., about 9 inches from the lower edge of the base 12 and about 6 inches from the upper edge of the base 12.

Instead of the handle 16, another manual gripping structure can be arranged in connection with the base 12 to enable the base 12 to be held down, for example, during the cutting stroke.

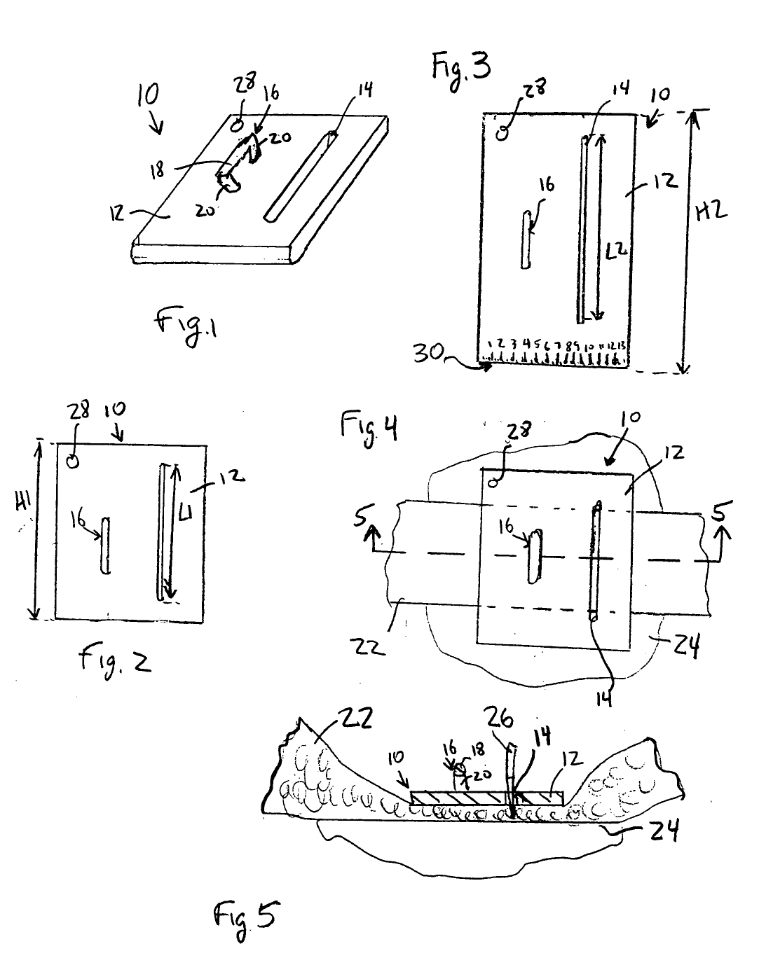

Referring now to FIGS. 4 and 5, in use, insulation material 22 is unwound from a roll and placed on a surface 24. The base 12 is then grasped manually by the handle 16 and placed over the insulation material 22 to compress the insulation material 22 between the base 12 and the underlying surface 24 upon exertion of force by the user's hand against the handle 16. The base 12 is preferably placed such that the underlying surface 24 is visible at the upper and lower end of the slot 14 (see FIG. 4). This signifies that the entire width of the insulation material is below the slot 14. While the user is holding the base 12 down with one hand via the handle 16, the user takes a knife or other cutting implement 26 in his other hand and beginning at either the upper or lower end of the slot 14, moves the cutting implement toward the other end of the slot 14 to thereby cut the insulation material below the slot 14. The overhang on either side of the slot 14 inhibits the insulation material 22 from interfering with the cutting process.

Various modifications to the apparatus 10 described above are also envisioned. For example, the base 12 may include one or more apertures 28 which enable the apparatus 10 to be hung up on a hook or the like. In the same manner, any type of mounting mechanism can be attached to or integrally formed with the base 12 to enable the base 12 to be mounted to, arranged on or suspended from a support structure.

Another optional modification is shown in FIG. 3 and constitutes ruler markings 30 formed along one edge of the base 12 to enable the apparatus 10 to be used to measure objects, e.g., the insulation being cut thereby. The markings 30 may be either in inches, metric units, or both, or formed along more than one side of the base 12, e.g., one side with metric units and the other side with inches.

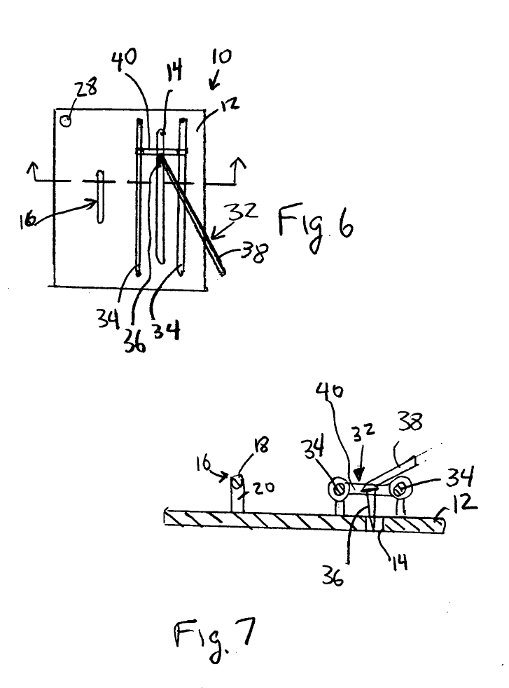

Another modification is shown in FIGS. 6 and 7 wherein the apparatus 10 includes a cutting tool 32 that slides along a pair of parallel tracks 34 arranged alongside the slot 14. The tracks 34 are mounted to the upper surface of the base 12. The cutting tool 32 includes a blade 36, a handle 38 attached at an angle to the blade 36 and a cross-piece 40 that engages with and slides along the tracks 34. To cause the blade 36 to pass through the slot 14, the handle 38 is manually grasped and then moved forward or backward causing the cross-piece 40 to slide along the tracks 34 and the blade 36 to pass through the slot 14 in its entirety. The cutting tool 32 can be designed so that the blade 36 is replaceable.

Instead of a pair of parallel tracks 34, it should be understood that it is possible to provide a single track along which the cutting tool 32 slides.

The apparatus 10 in any of the forms disclosed above is particularly useful in cutting insulation but may be used to cut any other type of material. For use in cutting insulation, however, the apparatus 10 is easy-to-use, safe and effective and can be constructed in a relatively from relatively inexpensive components. It enables insulation to be cut in a straight line across its width and entirely through its width in a single cutting stroke. Significant advantages over prior art techniques for cutting insulation are therefore provided by the apparatus 10.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. A cutting apparatus for cutting insulation, comprising:
a rigid base adapted to overlie insulation material, said base defining an elongate slot extending from an upper surface of said base to a lower surface of said base; and
a gripping structure arranged in connection with said base to enable said base to be manually placed over the insulation material whereby a cutting implement is passed through said slot in a longitudinal direction of said slot when said base overlies the insulation material to thereby cut the insulation material.

2. The apparatus of claim 1, wherein said slot is disposed on said base relative to left and right edges of said base to provide an overhang on either side of said slot.

3. The apparatus of claim 2, wherein said overhang is at least 6 inches.

4. The apparatus of claim 1, wherein said slot is disposed on a first portion of said base and said gripping structure is arranged on a second position of said base, the first and second portions being adjacent one another on said base.

5. The apparatus of claim 1, wherein said gripping structure comprises a handle having a gripping section spaced at a distance from said base and two legs extending between ends of said gripping section and said base.

6. The apparatus of claim 1, wherein said base has a generally planar form.

7. The apparatus of claim 1, wherein said slot is about 0.25 inches wide.

8. The apparatus of claim 1, wherein said base has a height of about 21 inches and said slot is parallel to left and right edges of said base and has a length of about 16 inches.

9. The apparatus of claim 1, wherein said base has a height of about 30 inches and said slot is parallel to left and right edges of said base and has a length of about 25 inches.

10. The apparatus of claim 1, wherein said slot is centered vertically so that there is approximately the same distance between an upper end of said slot and an upper edge of said base as compared to a distance between a lower end of said slot and a lower edge of said base.

11. The apparatus of claim 1, wherein said gripping structure is formed separate from said base and attached to said base.

12. The apparatus of claim 1, wherein said gripping structure is integral with said base.

13. The apparatus of claim 1, wherein said base includes an aperture to enable said base to be hung on a support structure.

14. The apparatus of claim 1, wherein said base includes ruler markings formed along at least one edge of said base.

15. The apparatus of claim 1, further comprising:
at least one track arranged in connection with said base parallel to said slot; and
a cutting tool arranged to slide along said at least one track, said cutting tool including a blade arranged to pass through said slot.

16. The apparatus of claim 15, wherein said at least one track comprises a pair of parallel tracks each arranged on a respective side of said slot.

17. The apparatus of claim 15, wherein said cutting tool further includes a handle attached to said blade.

18. The apparatus of claim 15, wherein said cutting tool further includes a cross-piece arranged to slide along said at least one track.

19. A method for cutting insulation, comprising the steps of:
placing a rigid base over a length of insulation material, the base defining an elongate slot extending from an upper surface of the base to a lower surface of the base; and then
passing a cutting implement through the slot to thereby cut the insulation material longitudinally alone the slot beneath the base.

20. The method of claim 19, further comprising the step of holding the base against the insulation material by exerting pressure on a gripping structure arranged in connection with the base.
